(19) United States
(12) Patent Application Publication
(10) Pub. No.: US 2008/0209724 A1
(43) Pub. Date: Sep. 4, 2008

(54) Support tube for a cold-shrink sleeve for joining electric cables

(75) Inventor: Patrick Andre, Francheville (FR)

Correspondence Address: SOFER & HAROUN LLP., 317 MADISON AVENUE, SUITE 910, NEW YORK, NY, 10017, US

(73) Assignee: Nexans

(21) Appl. No.: 12/070,724

(22) Filed: Feb. 20, 2008

Related U.S. Application Data
(62) Division of application No. 11/481,431, filed on Jul. 5, 2006, now abandoned.

(30) Foreign Application Priority Data
Aug. 8, 2005 (FR) 05 52461

(51) Int. Cl. H01R 43/20; H01R 43/04; B23P 11/02

(52) U.S. Cl. 29/881; 29/450

(57) ABSTRACT

A process for manufacturing an electrical cable joint by means of a shrink sleeve supported by a tube including supporting the shrink sleeve, in an expanded state, with the tube, where the tube is an open tube fitted on its two longitudinal edges with mutual engagement means. The mutual engagement means are engaged with one another while the tube is supporting the shrink sleeve. The mutual engagement means are then disengaged and the tube is removing from the shrink sleeve, allowing the shrink sleeve to shrink onto the joint.

### RELATED APPLICATION

This application is divisional application of U.S. patent application Ser. No. 11/481,431, which in turn claims the benefit of priority from French Patent Application No. 05 52068, filed on Jul. 6, 2005, the entirety of which are incorporated herein by reference.

### FIELD OF THE INVENTION

The invention relates to a support tube for a cold-shrink sleeve for joining electric cables.

### BACKGROUND OF THE INVENTION

When making such a joint, once the conductor has been connected, two circular-section cylindrical support tubes made of plastics material, e.g. polypropylene, and covered in a cold-shrink elastomer sleeve, are placed end to end over the connection, and then the support tubes are withdrawn by being pulled away and by being broken on either side of the joint, with the sleeve shrinking to cover intimately the connection together with the ends of the cables.

It is known to make such support tubes by means of two half-tubes that are welded together by ultrasound welding over two zones in the proximity of the ends of the half-tubes. The resulting support tube presents four longitudinal weld zones extending along two diametrically opposite generator lines.

That configuration presents the following technical problems.

The two half-tubes are injection molded, and because of mold shrinkage the half-tubes are not perfectly cylindrical. They are deformed, and as a result their mutual engagement in the vicinity of the welds is not perfect.

The tube tends to deform under the pressure exerted by the sleeve. In the central zone of the tube, the half-tubes are not connected together, and as a result there is relative displacement between the half-tubes, which is accompanied by effects of warping, gaping, and ovalizing of the resulting support tube.

In the end zones, the welding leads to beads on the inside of the tube that come into contact with, and catch on, the parts located inside the tube when it is installed on the cables and the connection between.

When mounted on the joint, the support tube is removed by being pulled and broken. The breaking takes place along the weld zones. These weld zones are therefore difficult to make. A compromise must be found between the strength needed for holding the two half-tubes properly and sufficient weakness for breaking to be relatively easy when the tube is removed.

Ultrasound welding is an operation that is expensive in terms of labor and maintenance, and it is also very noisy.

It is also known from patent document FR 2 810 465 to make a shrink-sleeve support tube for joining electric cables that is to support a sleeve in an expanded state and that is then to be removed so as to allow the sleeve to shrink onto the joint, which support tube is constituted by an open tube.

Such a support tube is held in its closed position solely by the radial pressure exerted by the shrink sleeve, once it has been placed on the tube.

The method of fabricating and mounting the shrink sleeve on the support tube is complex since it is necessary to use external tooling of the circular band type in order to hold the support tube closed while the sleeve is being put into place thereon.

### OBJECT AND SUMMARY OF THE INVENTION

The invention solves this problem, and to do this the invention provides a shrink-sleeve support tube for supporting, in an expanded state, a sleeve for an electric cable joint, and then for being removed so as to allow the sleeve to shrink onto the joint, the support tube being constituted by an open tube, and the open tube is fitted on its two longitudinal edges with mutual engagement means.

The engagement means serve firstly to make it easy to close the support tube, and secondly they enable the support tube to be broken in regular manner at the end of assembling the joint.

In a preferred embodiment of the invention, said engagement means are distributed regularly along said longitudinal edges.

Preferably, said engagement means are constituted by snap-fastening teeth.

Advantageously, said longitudinal edges are constituted by mutual engagement tongues of thickness substantially equal to half the total thickness of the tube.

Preferably, said mutual engagement tongues on an edge alternate between being internal tongues and external tongues.

Advantageously, said snap-fastening teeth are disposed on the contacting faces of some of said tongues.

### BRIEF DESCRIPTION OF THE DRAWINGS

The invention is described below in detail with the help of figures that show merely a preferred embodiment of the invention.

FIGS. 1A to 1E are face, section, and perspective views of a support tube in accordance with the invention in the open position.

FIGS. 2A to 2E are face, section, and perspective views of a support tube in accordance with the invention in the assembled position.

### MORE DETAILED DESCRIPTION

The figures thus show a support tube 1 for supporting a shrink sleeve for an electric cable joint, the tube serving to support a sleeve while it is in an expanded state and then to be removed so as to allow the sleeve to shrink onto the joint. The tube is constituted by an open tube fitted along its two longitudinal edges with mutual engagement means.

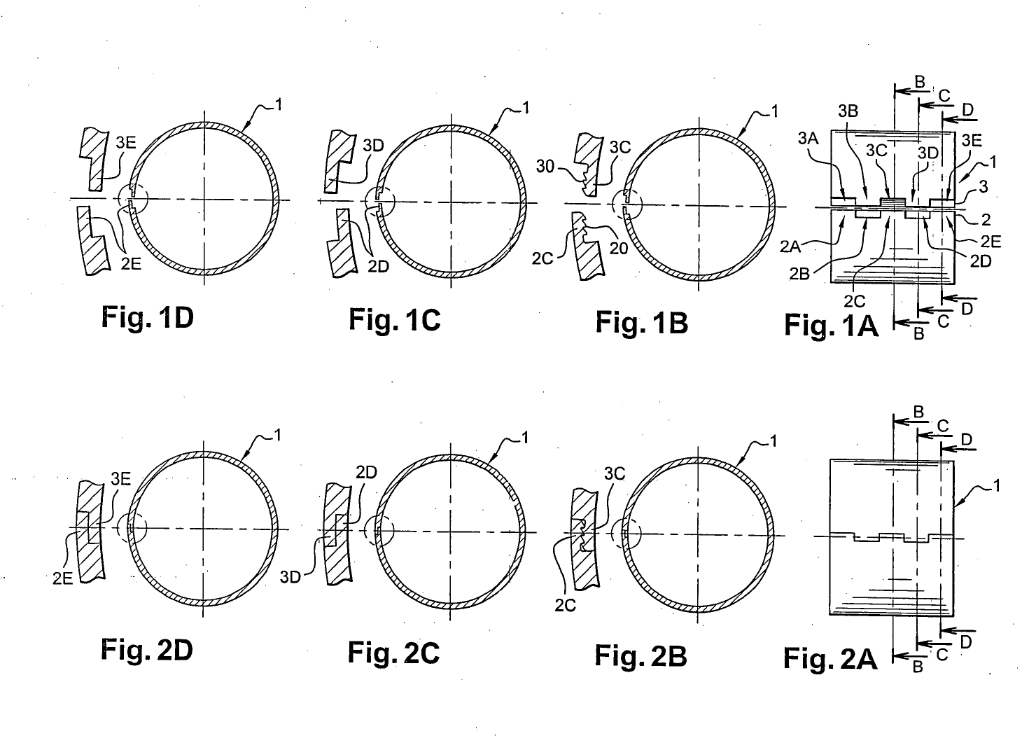

FIGS. 1A to 1D show the support tube when open, in the form it presents on leaving an injection mold. It is made of a plastics material, e.g. polypropylene.

The engagement means are regularly distributed along the longitudinal edges that are designed to be in alignment and connected together. These two longitudinal edges are constituted by engagement tongues of thickness equal substantially to half the total thickness of the tube, the engagement tongues along any one edge alternating between tongues that are internal and tongues that are external.

More precisely, with reference to an edge 2, it has a series of tongues, with every other tongue being internal such as the tongues referenced 2B and 2D, while the remaining tongues are external, such as the tongues referenced 2A, 2C, and 2E.

The other edge 3 is made in the same manner but with the tongues being in the opposite positions, so as to enable the tongues on the two edges 2 and 3 to engage mutually when these two edges are brought into alignment and pressed against each other.

In the embodiment shown, the tongues are all identical in length. However, advantageously, by making the engagement tongues of different lengths, it is possible to adjust the holding force of the tube, and this is beneficial when tearing the tube away from the conductor.

A certain number of tongues are provided with engagement means constituted by snap-fastening teeth 20, 30 disposed on the contacting faces of some of the tongues 2C, 3C. These engagement means are disposed along the total length of the tube 1.

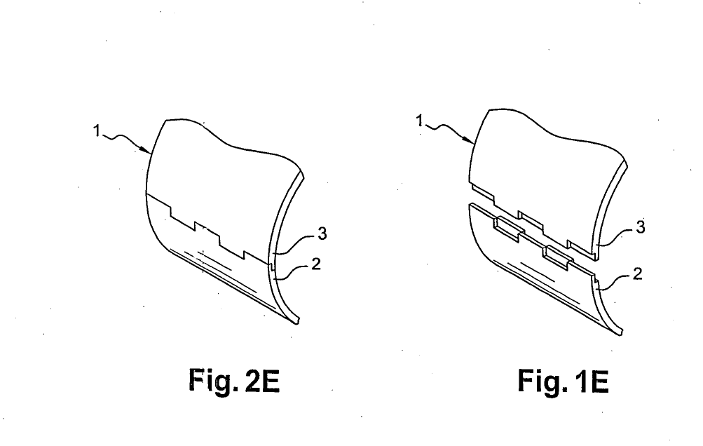

On leaving the mold, the support tube 1 is closed as shown in FIGS. 2A to 2E.

The facing tongues on the two edges 2 and 3 engage mutually one on another and the tongues 2C, 3C carrying the snap-fastening teeth catch one on the other.

The support tube 1 is then ready to be used as a support for a shrink sleeve for an electric cable joint, the sleeve being placed in an expanded state on the support tube 1 which is then placed over a joint from which it is removed by being pulled away and broken, so as to enable the sleeve to shrink onto the joint.

The tube in accordance with the invention can be clipped together directly on leaving its mold by a robot or some other automatic means, thereby protecting the snap-fastening teeth and the mutual engagement tongues during transport, and thus avoiding an additional station for closing the tube.

What is claimed is:

1. A process for manufacturing an electrical cable joint by means of a shrink sleeve supported by a tube, said method comprising the steps of:
supporting said shrink sleeve, in an expanded state, with said tube, said tube being an open tube fitted on its two longitudinal edges with mutual engagement means;
mutually engaging said mutual engagement means while said tube is supporting said shrink sleeve;
disengaging said mutual engagement means on said tube; and
removing said tube from said shrink sleeve, allowing said shrink sleeve to shrink onto said joint.

2. The method as claimed in claim 1, wherein said mutual engagement means on said tube are distributed regularly along said longitudinal edges.

3. The method as claimed in claim 1, wherein said mutual engagement means are snap-fastening teeth.

4. The method as claimed in claim 1, wherein said longitudinal edges of said tube are mutual engagement tongues of thickness substantially equal to half the total thickness of the tube.

5. The method as claimed in claim 4, wherein said mutual engagement tongues on said longitudinal edge of said tube alternate between being internal tongues and external tongues.

6. The method as claimed in claim 4, wherein said mutual engagement means are snap-fastening teeth that are disposed on the contacting faces of at least one of said tongues.
